(19) United States
(12) Patent Application Publication
(10) Pub. No.: US 2007/0277005 A1
(43) Pub. Date: Nov. 29, 2007

(54) Recording Medium, Data Processing Apparatus, and Data Processing Method

(76) Inventors: Hirokazu So, Osaka (JP); Shinji Inoue, Osaka (JP); Makoto Ochi, Osaka (JP)

Correspondence Address: Randolph A. Smith;Smith Patent Office, 1901 Pennsylvania Ave., N.W., Suite 901, Washington, DC, 20006-3433, US

(21) Appl. No.: 10/576,422

(22) PCT Filed: Oct. 22, 2004
(86) PCT No.: PCT/JP04/15691

§ 371 Date: May 5, 2007

(30) Foreign Application Priority Data
Oct. 27, 2003 (JP) 2003-365659

(51) Int. Cl. G06F 12/00

(52) U.S. Cl. 711/154

(57) ABSTRACT

In addition to a nonvolatile recording area, a host interface, a controller and an update notification part are provided with a recording medium. The controller reads and writes data from and to the recording area, and sends the data of the recording area and update information to a data processing apparatus via the host interface part. In particular, the present invention is characterized in that updated information of the update notification part is updated immediately before data of the recording area is updated. The value of the update notification part can be referred to from the data processing apparatus but cannot be updated thereby. The data processing apparatus holds update information of the update notification part, whereby it can determine whether or not data stored in the recording area has been updated by another data processing apparatus. In this way, it becomes possible to determine the validity of the cache information and also determine that of index files.

### TECHNICAL FIELD

The present invention relates to a readable and writable recording medium, and a data processing apparatus and data processing method for processing data stored in the recording medium.

### BACKGROUND ART

In recent years, as recording media which can write digital data thereto or read digital data therefrom, card-like semiconductor memories of various types which incorporate a nonvolatile semiconductor memory therein has been widespread. The data processing apparatuses which process data by using these semiconductor memories are used in various applications including electric appliances such as personal computers, audio equipments, visual equipments, mobile telephones and digital cameras.

Removable recording media with excellent portability such as semiconductor memories are especially useful as bridge media for exchanging data between data processing apparatuses. For this reason, one recording medium is often used by a plurality of data processing apparatuses through being attached to and detaches from them. Therefore, data which is stored in the recording medium by a data processing apparatus may be updated by other data processing apparatuses. Thus, when the recording medium detached from a data processing apparatus once is attached to the apparatus again, the data processing apparatus has to confirm whether or not contents in the recording medium are updated to use it.

There has been such a problem that the larger the size of the read data becomes, the longer processing time becomes, since a data processing apparatus has to confirm contents of data recorded in the recording medium after actually reading the data to determine whether or not the data in the recording medium may have been updated by another data processing apparatus.

Update information updated each time data is written to the recording medium includes the number of times of writing for every block in the recording medium and a recording method is disclosed in Japanese Unexamined Patent Publication No. 2000-45858, for example. However, the number of times of writing for every block is used only in the recording medium and is not disclosed to the data processing apparatus. For this reason, it cannot be used to detect whether or not data has been updated.

The conventional recording medium has had such a problem that it takes a long time to confirm the data in the recording medium since the data processing device cannot easily determine whether or not data stored in the removable, readable and writable recording medium has been updated.

Patent document 1: Japanese Unexamined Patent Publication No. 2000-45858.

### DISCLOSURE OF INVENTION

### Problems to be Solved by the Invention

To solve these problems, an update notification part for notifying that data has been updated immediately before data writing is provided in the recording medium. Update information of the update notification part is allowed to be referred by a data processing apparatus and is not allowed to be updated by the data processing apparatus. A main purpose of the present invention is to certainly notify the possibility of the update to the data processing apparatus in this manner.

### Means for Solving the Problems

A recording medium of the present invention is provided with a nonvolatile recording area for storing data therein, an update notification part for updating update information when writing or erasing the data in the recording area and for holding the updated update information, a host interface part for communicating with a host device and a controller for reading and writing data from and to the recording area and for sending the data in the recording area and update information to the host device via the host interface part. The update information in the update notification part can be read but cannot be written by the data processing apparatus.

### EFFECTS OF THE INVENTION

By using such recording medium and data processing method, it is easily possible to determine whether or not data in the recording medium may have been updated by other data processing apparatuses. Therefore, when the recording medium, during the data processing, is detached or power-off of the recording medium occurs, it is possible to determine in a short time whether or not the data stored in the recording medium may have been updated. When the data has not been updated, cache information stored in the data processing apparatus can be used as it is.

### BRIEF DESCRIPTION OF DRAWINGS

FIG. 1 is a configuration view of a recording medium 100 in embodiments of the present invention.

FIG. 2 is a flowchart showing an operation sequence of the recording medium 100 at the time of receipt of a command in a embodiment 1 of the present invention.

FIG. 3 is a block diagram showing a configuration of a data processing apparatus 200 in embodiments of the present invention.

FIG. 4 is a flowchart showing an operation sequence in the case where the recording medium 100 is attached to the data processing apparatus 200 in embodiment 1 of the present invention.

FIG. 5 is a flowchart showing an operation sequence in the case where the data processing apparatus 200 reads data in the recording medium 100 in embodiment 1 of the present invention.

FIG. 6 is a flowchart showing an operation sequence in the case where the data processing apparatus 200 writes data to the recording medium 100 in embodiment 1 of the present invention.

FIG. 7 is a flowchart showing an operation sequence at the time of power-on of the data processing apparatus 200 in embodiment 1 of the present invention.

FIG. 8 is an explanatory view showing a data structure of a recording area 130 in embodiment 2 of the present invention.

FIG. 9 is a flowchart showing an operation sequence in the case where the recording medium 100 is attached to the data processing apparatus 200 in embodiment 2 of the present invention.

FIG. 10 is a flowchart showing an operation sequence of creating an index file 300 in embodiment 2 of the present invention.

FIG. 11 is a flowchart showing an operation sequence at the time of power-on of the data processing apparatus 200 in embodiment 2 of the present invention.

FIG. 12 is a flowchart showing an operation sequence of the recording medium 100 at the time of receipt the command in embodiment 3 of the present invention.

FIG. 13 is a flowchart showing an operation sequence of creating the index file 300 in embodiment 3 of the present invention.

### DESCRIPTION OF REFERENCE NUMERALS

100 Recording medium
110 Host interface part
120 Controller
130 Recording area
131 Data storage area
132 Search information storage area
140 Update notification part
150 Medium ID holder
200 Data processing apparatus
210 Slot
220 Input/output processor
230 Data processor
231 Update information storage area
232 Medium-specific ID storage area
233 Cache information storage area
240 User input processor
250 Display processor
300 Index file

### BEST MODE FOR CARRYING OUT THE INVENTION

Hereinafter, a recording medium, data processing apparatus and data processing method will be described referring figures.

### Embodiment 1

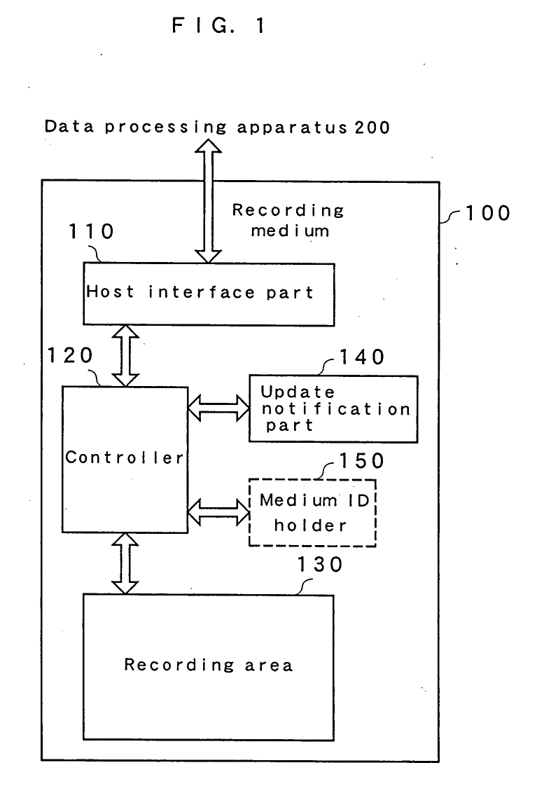

First, a recording medium in accordance with embodiment 1 of the present invention will be described. FIG. 1 is a configuration view of a recording medium 100 as a semiconductor memory of the present invention. The recording medium 100 includes a host interface part 110, controller 120, recording area 130, an update notification part 140 and medium ID holder 150. Such the recording medium 100 is inserted into a slot of a data processing apparatus 200 and data is read from and written to. That is, the data processing apparatus 200 is a host device which reads and writes data from and to the recording medium 100.

The host interface part 110 delivers and receives information such as commands and data to or from the data processing apparatus 200. The controller 120 controls the recording area 130, update notification part 140 and medium ID holder 150 in the recording medium 100 to read and write data from and to the recording area 130, and provides the data and update information in recording area 130 to the data processing apparatus 200 as a host device via the host interface part 110. The recording area 130 is an area where digital data is stored and any digital data can be read and written from and to the data processing apparatus 200.

When data in any part of the recording areas 130 can be written or erased, the update information is updated by the controller 120 and the update notification part 140 holds the value. When the update information is numerical information, the update notification part 140 may be formed of a counter. The update information may be held in a part of the recording area 130. The update information can be read by the data processing apparatus 200 via the controller 120 and host interface part 110. However, the update information cannot be set as any value from the data processing apparatus 200. In the present embodiment, the size of the update information stored in the update notification part 140 is set to be 64 bits as an example.

An initial value 0, at the time of manufacturing of the recording medium 100, is written as the update information in the update notification part 140 and the value is not cleared thereafter. That is, even if the power of recording medium 100 is turned off or a reset command is issued from the data processing apparatus 200, the value of the update notification part 140 does not return to the initial value.

The medium ID holder 150 is a memory for storing a medium-specific ID which varies depending on the recording medium therein. Although the medium ID holder 150 is not necessarily required, it is provided in this embodiment. In this embodiment, the memory size of the medium ID holder 150 is set to be 64 bits as an example.

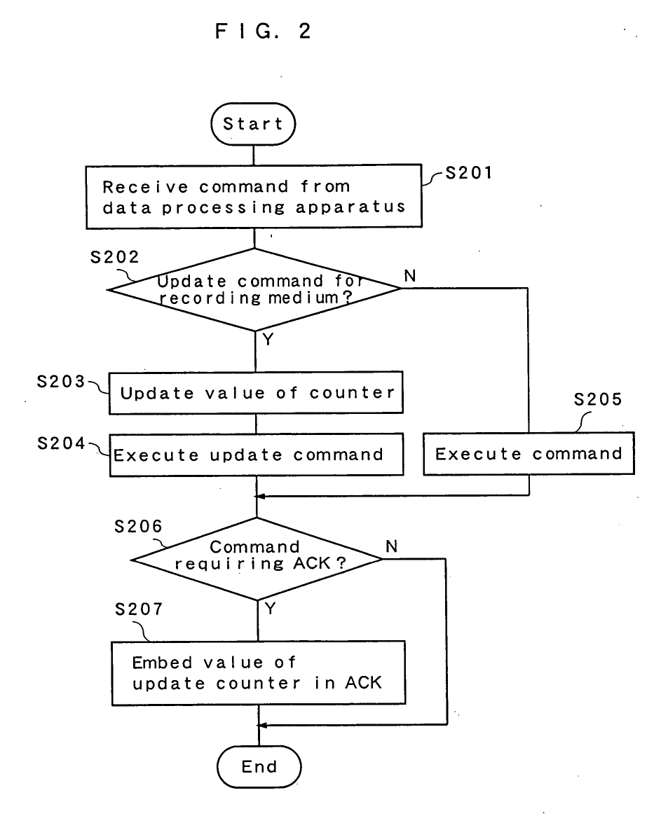

Hereinafter, operations of each part constituting the recording medium 100 will be described referring to figures. FIG. 2 is a flowchart showing a general operation sequence at the time when the recording medium 100 receives a command from the data processing apparatus 200. The command includes a write command, read command, an erase command or initialization command of data. At a step S201, when receiving the command from the data processing apparatus 200, the host interface part 110 notifies the command to the controller 120. At a step S202, the controller 120 determines the type of the command notified at the step S201 and whether or not the command is a command to update data in the recording area 130. The commands to update the recording area 130 include the write command to write data and erase command to erase data. When it is a command to update data, the operation proceeds to processing at a step S203. When it is the other command, the operation proceeds to a processing at a step S205. The other command is, for example, the read command to read data.

At the step S203, the controller 120 increments the value of the update information in the update notification part 140. Although the increment means addition of 1 in this embodiment, however, it is not limited to this. At the step S204, the controller 120 executes the received update command. For example, when the command is the write command, the data received from the data processing apparatus 200 is written to the recording area 130. When the command is the erase command, the data at a corresponding address of the recording area 130 is erased. If the processing is completed, the operation proceeds to a step S206. At the step S205, the received command (read command, etc.) is executed and the operation proceeds to the step S206.

At the step S206, determination is made whether or not the received command requires that the recording medium 100 returns a response value (ACK) to the data processing apparatus 200. When a field which stores the update information in the update notification part 140 therein is prepared in the response value (ACK), the operation proceeds to a step S207, and when not prepared, the processing is completed. At the step S207, the current update information in the update notification part 140 is embedded in the response value (ACK) and transmitted to the data processing apparatus 200 to complete the processing.

As described above, the recording medium 100 in this embodiment updates the value of the update notification part 140 when the data in the recording area 130 can be written and just before the data is updated. Therefore, even when the power-off or detachment of the card (recording medium) occurs during execution of the command and thus the processing is aborted, the update information in the update notification part 140 is updated. That is, the value of the update information in the update notification part 140 represents the number of times when the recording medium 100 may have been updated rather than it was actually updated. For this reason, when the value of the update information in the update notification part 140 is not changed, the data in the recording area 130 is regarded as not-updated.

In this embodiment, the recording medium 100 has a command by which the data processing apparatus 200 reads the value of the update notification part 140 at any timing.

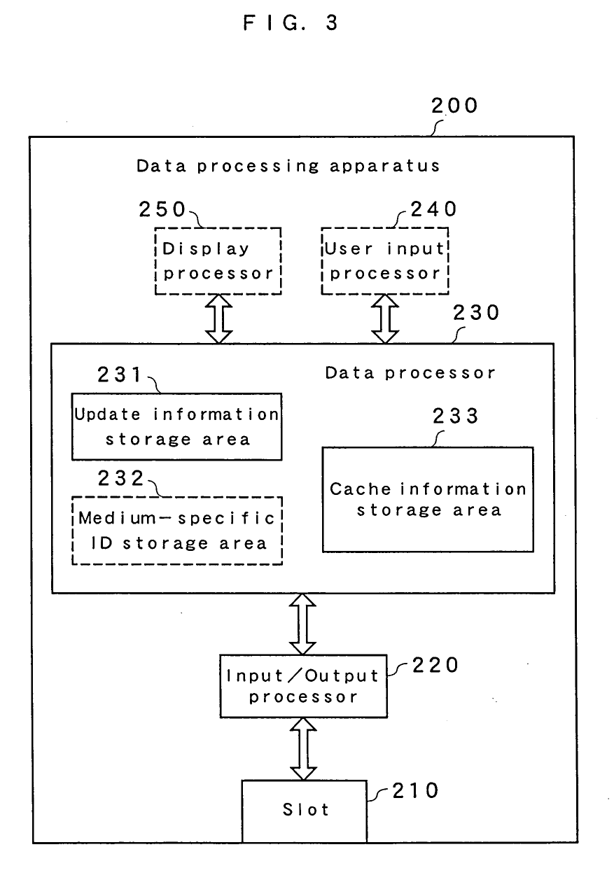

Next, the data processing apparatus 200 in this embodiment will be described. FIG. 3 is a block diagram showing a configuration example of the data processing apparatus 200. The data processing device 200 mounts the recording medium 100 to perform data processing and includes a slot 210, input/output processor 220, data processor 230, user input processor 240 and display processor 250. The slot 210 is a hardware for the attachment of the recording medium 100. The input/output processor 220 delivers and receives information such as the command and data to and from the recording medium 100 attached to the slot 210. The data processor 230 processes the data stored or to be stored in the recording medium 100 and serves to perform main processing of the data processing apparatus 200. The data processor 230 has an update information storage area 231, medium-specific ID storage area 232 and cache information storage area 233. For example, when the data stored in the recording medium 100 is audio data or video data, the data processor 230 may read the data via the input/output processor 220 and play the data. Alternatively, the data processor 230 may write the recorded and edited data to the recording medium 100 via the input/output processor 220. The data processor 230 has a memory, as a temporary storage area, used during data processing.

The update information storage area 231 is an area for storing the update information in the update notification part 140 of the recording medium 100 therein. The medium-specific ID storage area 232 is an area for storing the value of the medium ID holder 150 of the recording medium 100. When the recording medium 100 does not have the medium ID holder 150, the area may not be necessarily provided and however, it is provided in this embodiment. The cache information storage area 233 is an area for storing newest data read from the recording medium 100. By storing data to be frequently read among the data stored in the recording medium 100, the number of times of accesses to the recording medium 100 can be reduced, thereby the processing.

The user input processor 240 is a part for receiving an input from a user. Although the user input processor 240 is not necessarily required, it is provided in this embodiment. The display processor 250 is a part for notifying results and progress of processing in the data processor 230 to the user. Although the display processor 250 is not necessarily required, it is provided in this embodiment.

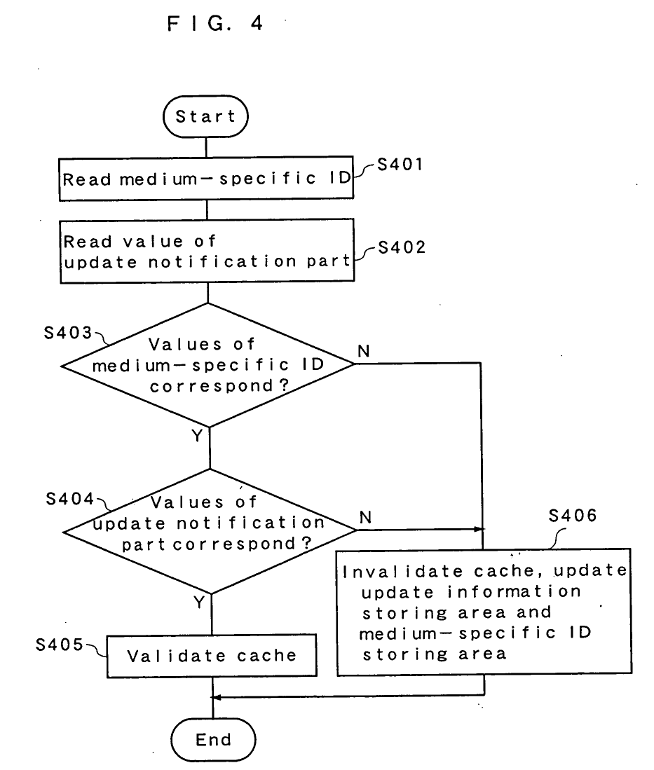

Hereinafter, operations of parts constituting the recording medium 100 and data processing apparatus 200 will be described referring to figures. FIG. 4 is a flowchart showing an operational sequence in the case where the recording medium 100 is mounted to the data processing apparatus 200. At a step S401, the data processor 230 reads the value of the medium ID holder 150 of the recording medium 100 attached to the slot 210 via the input/output processor 220 and temporarily stores the value in the memory. At a step S402, the data processor 230 reads the update information in the update notification part 140 of the recording medium 100 attached to the slot 210 and temporarily stores the update information in the memory. At a step S403, the value of the medium ID holder 150 read at the step S401 is compared to the value stored in the medium-specific ID storage area 232. When the values correspond to each other, the operation proceeds to a step S404 and when the values do not correspond to each other, the operation proceeds to the step S406.

At the step S404, the update information in the update notification part 140 read at the step S402 is compared to the update information stored in the update information storage area 231 of the data processor 230. When both update information correspond to each other, the operation proceeds to a step S405 and when both update information do not correspond to each other, the operation proceeds to the step S406. At the step S405, the data processor 230 determines that the data stored in the recording medium 100 attached to the slot 210 has not been updated since the last attachment. Then, it is determined that the cache data stored in the cache information storage area 233 is dealt with as valid data. When the operation proceeds to the step S406, the data processor 230 determines that the data stored in the recording medium 100 attached to the slot 210 has been updated since the last attachment. Then, it is determined that the cache data stored in the cache information storage area 233 is dealt with as invalid data. At this time, all area of the cache information storage area 233 may be cleared. Furthermore, the value of the medium ID holder 150 temporarily stored at the step S401 is overwritten in the medium-specific ID storage area 232 and the update information in the update notification part 140 temporarily stored at the step S402 is overwritten in the update information storage area 231.

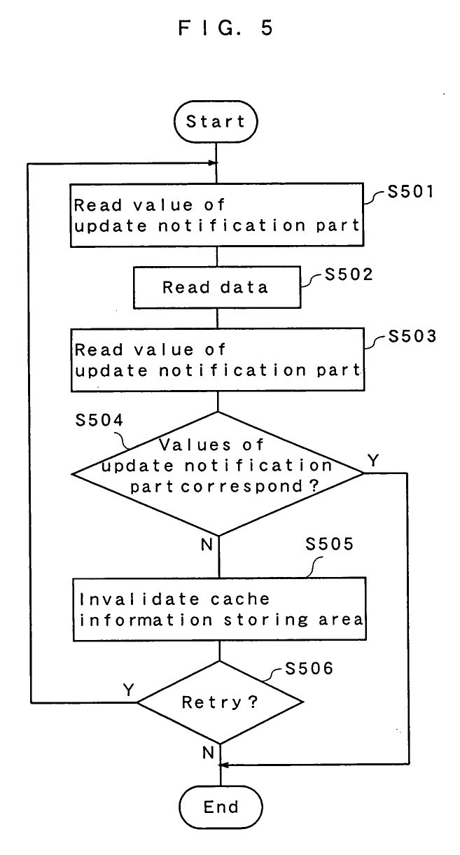

FIG. 5 is a flowchart showing an operation sequence in the case where the data processing apparatus 200 reads the data in the recording medium 100. At a step S501, the data processor 230 reads the update information in the update notification part 140 of the recording medium 100 attached to the slot 210 via the input/output processor 220 and temporarily stores the update information in the memory. At a step S502, the data processor 230 issues the read command to the recording medium 100 attached to the slot 210 via the input/output processor 220 and reads data from the recording medium 100. Here, the read data may be stored in the cache information storage area 233. When the read processing is completed, the operation proceeds to a step S503. At the step S503, the data processor 230 reads the update information in the update notification part 140 of the recording medium 100 attached to the slot 210 again and temporarily stores the update information in the memory.

At a step S504, the update information in the update notification part 140 read at the step S501 is compared to the update information in the update notification part 140 read at the step S503. That is, it is checked whether or not the value of the update notification part 140 changes before and after reading of the data at the step S502. When the read processing is normally completed, the values correspond to each other. However, the values do not correspond to each other when the data is updated during reading for any reason. When the values correspond to each other, the operation is finished. When the values do not correspond to each other, the operation proceeds to a step S505. At the step S505, an error processing is executed since reading of the data is considered to fail at the step S502. It is determined that reliability of the data in the cache information storage area 233 is impaired and the data is made invalid. At the step S506, in the case where completion of the processing by error is simply performed, the operation is directly finished. And in the case where retry processing is performed, the operation returns to the step S501 and processing starts again. The number of times of retry processing may be restricted to the limited number of times. By using the operation sequence in FIG. 5, reliability of the read data can be improved.

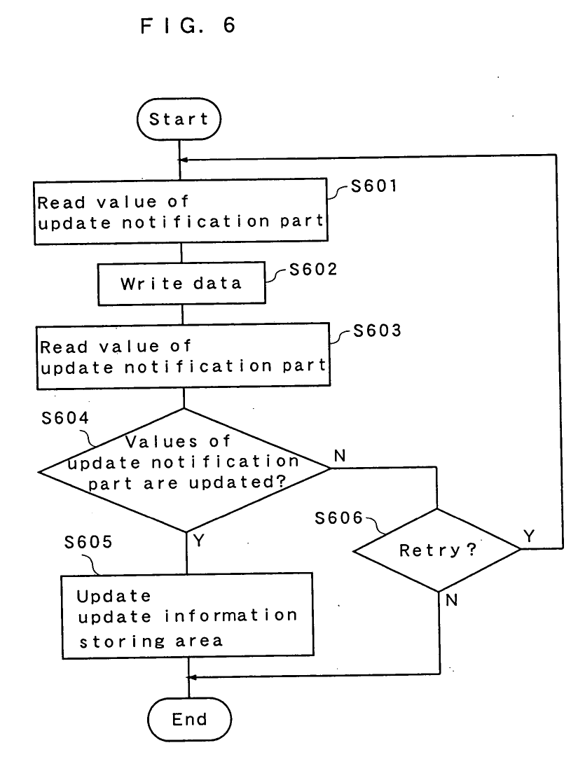

FIG. 6 is a flowchart showing an operation sequence in the case where the data processing apparatus 200 writes data to the recording medium 100. At a step S601, the data processor 230 reads the update information in the update notification part 140 of the recording medium 100 attached to the slot 210 via the input/output processor 220 and temporarily stores the update information in the memory. At a step S602, the data processor 230 issues the write command to the recording medium 100 attached to the slot 210 via the input/output processor 220 and transmits the data to be written to the recording medium 100. When the writing processing is completed, the operation proceeds to a step S603. The data processor 230 reads the update information in the update notification part 140 of the recording-medium 100 attached to the slot 210 via the input/output processor 220, and makes it stored temporarily in a memory at the step S603. At a step S604, the update information in the update notification part 140 read at the step S601 is compared to the update information in the update notification part 140 read at the step S603. That is, it is checked whether or not the update information in the update notification part 140 changes before and after writing of the data at the step S602. When the writing processing starts in the recording medium 100, the update information is updated and when the data is not written for any reason, the update information is not updated. When the update information is updated, the operation proceeds to the step S605. When the update information is not updated, the operation proceeds to the step S606. At the step S605, the data processor 230 overwrites the value of the update information storage area 231 with the value temporarily stored at the step S603.

Furthermore, when the data in the recording medium 100 corresponding to the data stored in the cache information storage area 233 is overwritten by the writing at the step S602, the data in the cache information storage area 233 is made invalid. The data in the cache information storage area 233 may be made invalid at all times for the simplification of the processing.

At a step S606, since it is considered that the writing of the data at the step S602 fails, the error processing is executed. In the case where completion of the processing by error is simply performed, the processing is directly finished. When the retry processing is performed, the operation proceeds to the step S601 and the processing starts again. The number of times of retry processing may be restricted to the limited number of times.

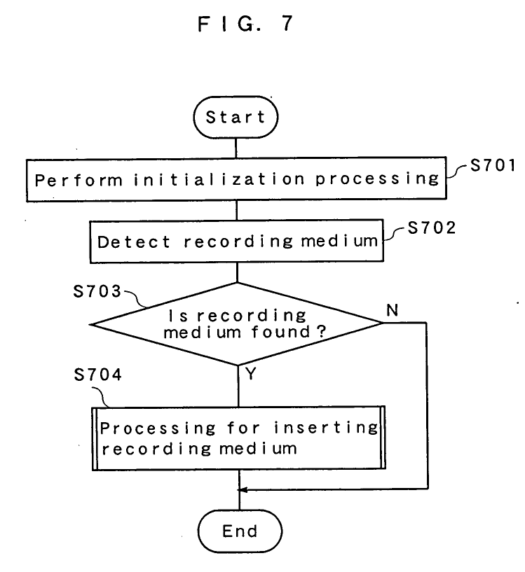

FIG. 7 is a flowchart showing an operation sequence at the time of power-on of the data processing apparatus 200. At a step S701, when the power of the data processing apparatus 200 is turned on, the input/output processor 220, data processor 230, user input processor 240 and display processor 250 in the data processing apparatus 200 perform initialization processing. The initialization processing is processing of performing initial setting of hardware and software and includes clearance of an internal memory and setting initial values. At this time, the data processor 230 clears values of the update information storage area 231, medium-specific ID storage area 232 and cache information storage area 233.

At a step S702, the input/output processor 220 determines whether or not the recording medium 100 is attached to the slot 210. At a step S703, when the recording medium 100 is determined to be attached to the slot 210 judging from a result of the determination at the step S702, the operation proceeds to a step S704. When not attached, the processing at the time of power-on is completed. At the step S704, the operation sequence explained in FIG. 4 is executed for the recording medium 100 attached to the slot 210 and the processing at the time of power-on is completed.

After the operation sequence at the time of power-on is completed, the data processing apparatus 200 performs processing of data stored in the recording medium 100 using the input of the user received in the user input processor 240 as a trigger. It is possible that the input processor 240 does not exist and software stored in the data processor 230 automatically starts the processing of the data stored in the recording medium 100. In each operation sequence, the display processor 250 may display the progress and result to the user.

As described above, in accessing the recording medium 100, the data processing apparatus 200 uses the update information in the update notification part 140. Thereby, it is easily determined whether or not the cache information stored in the cache information storage area 233 can be reused when the recording medium 100 is attached to and when the cache information can be reused, the processing can be accelerated. It is also possible to more strictly check whether or not reading of the data from the recording medium 100 and writing of the data to the recording medium 100 have been normally performed.

Although the present invention has been described based on above-mentioned embodiment, the present invention is not limited to above-mentioned embodiment. Modification is possible as far as it does not deviate from the scope of the present invention. Cases of (1-1) to (1-14) described below are included in the concept of the present invention.

(1-1) Although the update notification part 140 is formed of a counter, it is not limited to this. Any configuration which, in the case where the value of the recording area 130 may have been updated, necessarily makes change in state and in which the data processing apparatus 200 can detect the change can be adopted.

(1-2) In this embodiment, although updating the update information in the update notification part 140 is incrementing the value, the other update methods can be applied. That is, decrement may be performed or a pseudo-random number may be set. Any update method in which the same value does not appear may be adopted.

(1-3) In this embodiment, although the recording medium 100 updates the update information in the update notification part 140 only once when it receives the command to update the recording area 130, the update information may be updated plural times. For example, in the case of a multi-write command to write data to a plurality of sectors by one command, update may be performed the same number of times as the number of the sectors to be written.

(1-4) Although the initial value of the update information in the update notification part 140 of the recording medium 100 is set to be 0 at the time of manufacturing in this embodiment, the initial value may be any value other than 0. For example, the initial value may be determined according to the medium ID holder 150. For example, the initial value of the update notification part 140 may be set to be the value of medium ID holder 150. Since the values of the medium ID holder 150 varies for every recording medium, the initial value of the update notification part 140 can be varied for every recording medium.

(1-5) Although the size of the update notification part 140 is set to be 64 bits in this embodiment, it may be set as any length. Effects of the present invention can be realized more stably by using the size of the digit number such that the same value does not appear again.

Furthermore, the data processing apparatus 200 may have workings for detecting that the value of the update notification part 140 has taken a round. For example, the recording medium 100 may have a specification in which the value of the update notification part 140 need not be updated when it becomes representable maximum value. That is, when the value of the update notification part 140 becomes maximum value, the data processing apparatus 200 does not use it. Alternatively, the recording medium 100 may have a specification in which writing cannot be performed when the value of the update notification part 140 has taken a round.

(1-6) Although the memory size of the medium ID holder 150 is set to be 64 bits in this embodiment, it may be set to be any length.

(1-7) Although the recording medium 100 is a semiconductor memory in this embodiment, any removable, readable and writable recording medium can realize the effects of the present invention. As a recording medium other than the semiconductor memory, a removable HDD, for example, may be used.

(1-8) Although the data processing apparatus 200 has one slot 210 in this embodiment to clearly describe the point of the present invention, a plurality of slots 210 may be provided.

Similarly, although the medium-specific ID storage area 232 and cache information storage area 233 can store information only in one recording medium 100 therein, they may store information in a plurality of recording media 100 therein. Since the rate of reuse of the cache information increases at this time, speed-up of the processing can be expected.

(1-9) In this embodiment, the update information in the update notification part 140 before the reading processing is compared to that after reading processing in the operation sequence in FIG. 5. This confirms whether or not the reading processing is normally executed and if unnecessary, it may be omitted.

As another method of confirming the reading processing, there is a method of confirming whether the data size actually read by the data processing apparatus 200 corresponds to the size designated at the time of reading.

In this embodiment, the update information in the update notification part 140 before the writing processing is compared to that after reading processing in the operation sequence in FIG. 6. This confirms whether or not the writing processing is normally executed and if unnecessary, it may be omitted. In the operation sequence in FIG. 6, the data written immediately after the writing processing may be read to confirm correspondence of the data.

(1-10) In this embodiment, since the data processor 230 clears the values of the update information storage area 231, medium-specific ID storage area 232 and cache information storage area 233 at the time of power-on of the data processing apparatus 200, when the power of the data processing apparatus 200 is turned off, the cache information is erased. However, the information in the update information storage area 231, medium-specific ID storage area 232 and cache information storage area 233 may be held in a nonvolatile memory so that the cache information may not be erased even when the power of the data processing apparatus 200 is turned off. On the contrary, a means of compulsorily resetting the cache information may be provided.

(1-11) In this embodiment, the value of the update information in the update notification part 140 is incremented each time the possibility of the update of the recording area 130 occurs, and by using this working, the following becomes possible.

The recording medium 100 has a function of setting or canceling write protect which prohibits writing to the recording area 130 and the controller 120 of the recording medium can determine the state of setting or cancellation of write protect via the host interface part 110. The value of the update notification part 140 of the data processing apparatus 200 is not incremented each time the possibility of update of the recording area 130 occurs but incremented each time write protect is cancelled. At this time, the data processing apparatus 200 can determine whether or not the write protect set in the recording medium 100 has been cancelled by another data processing apparatus.

(1-12) In this embodiment, the value of the update information in the update notification part 140 is incremented each time the possibility of update occurs in anywhere of the recording medium 130. However, the value of the update information in the update notification part 140 may have not to be updated for a certain area of the recording medium 130. Thereby, field of application of the recording medium 100 can be enlarged.

(1-13) In this embodiment, an example of existing one recording area 130 and one update notification part 140 corresponding to the recording area 130 in the recording medium 100 is described. However, a plurality of pairs of the recording area 130 and update notification part 140 may exist in the recording medium 100. At this time, each of the update notification parts 140 updates the update information when the possibility of update occurs in somewhere of the corresponding recording areas 130. Thus, since the possibility of update can be detected for every recording area, more precise control can be performed at the side of the data processing apparatus 200.

For example, when the recording medium 100 is an SD memory card, there exist a normal area as a recording area which can be freely accessed by the user and an authentication area as a recording area which can be accessed only when a specific authentication processing succeeds. At this time, two update notification parts 140 for the normal area and authentication area exist and each of the update notification parts 140 updates the update information each time the possibility of update occurs for the corresponding recording area 130.

(1-14) In this embodiment, an example of existing one recording area 130 and one update notification part 140 corresponding to it in the recording medium 100 is described. However, when a plurality of recording areas 130 exist in the recording medium 100, one update notification part 140 may exist for all or a part of the recording areas. At this time, the update notification part 140 updates the update information when the possibility of update occurs in any one recording area 130 among the plurality of corresponding recording areas 130. Thus, one update notification part 140 can manage update of the plurality of recording areas 130.

In the case of the SD memory card, for example, one update notification part 140 may exist for two recording areas of the normal area and authentication area and the update information in the update notification part 140 may be updated when the possibility of update occurs in either normal area or authentication area.

### Embodiment 2

Next, a recording medium and data processing method in accordance with embodiment 2 will be described based on figures. There are some data processing apparatuses without function of creating an index file. In such data processing apparatus, when data is written to or erased from the recording medium, the index file is not updated. When another data processing apparatus reads a file of the recording medium, even if the index file of the recording medium is looked and a contents file is taken out, contents of the contents file may not correspond to contents of the index file.

In this embodiment, by providing an update information field in the index file and storing the update information of the update notification part in the update information field, it is possible to easily confirm whether or not the contents of the contents file correspond to the contents of the index file.

The block configuration of the recording medium 100 in embodiment 2 is the same as that in embodiment 1 as shown in FIG. 1. The recording medium 100 in embodiment 2, provides the update information field in the index file of the data storage area provided in the recording area. Thus, in the case where a plurality of data processing apparatuses exist, even when the recording medium 100 is inserted into any of the data processing apparatuses, the update state of the recording area can be confirmed.

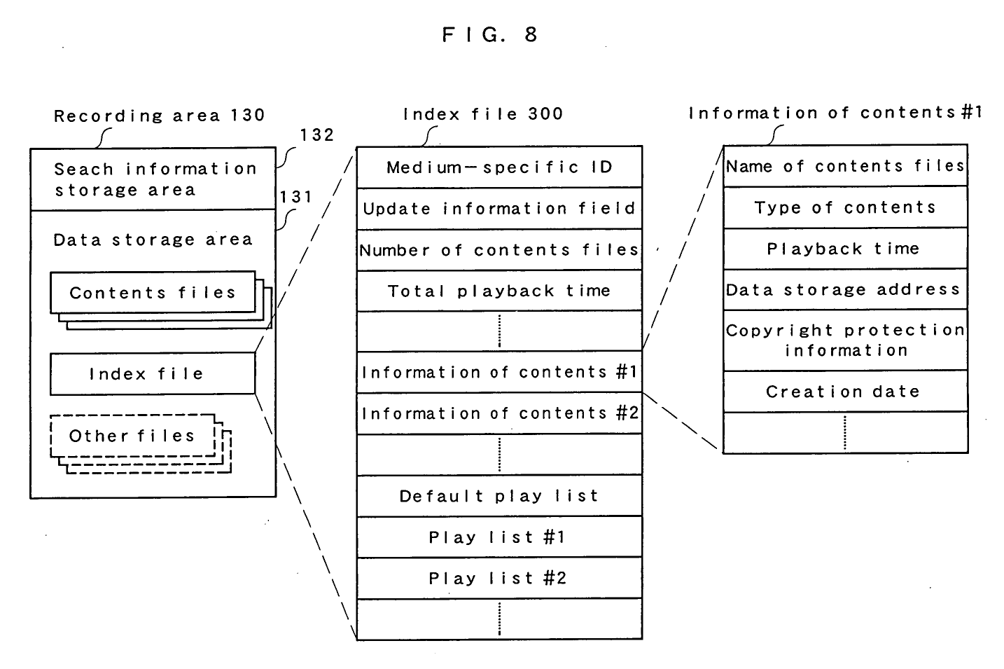

FIG. 8 is an explanatory view showing a data structure of data stored in the recording area 130 in the recording medium 100 in this embodiment. The record area 130 includes a data storage area 131 and search information storage area 132. The data storage area 131 is an area for storing a plurality of pieces of data therein. In this embodiment, each data is stored in the form of a file and at least one contents files and index file 300 are stored. However, the other files may be stored. The contents file is a file which stores contents data such as music, motion picture and still picture.

The index file 300 is a file which stores the information of a plurality of contents files and has fields for storing, in particular, the following information therein. That is, the information includes the value of the medium-specific ID 150 of the recording medium 100, update information in the update notification part 140 of the recording medium 100, the number of contents files recorded in the recording medium 100, total playback time of the contents file recorded in the recording medium 100, information in each contents file and play list describing playback order of the contents files. Especially, a field for storing the update information in the update notification part 140 of the recording medium 100 is referred to as the update information field.

The information of the contents files is specifically the following information. That is, the information includes names of the contents files, a type of contents such as music, motion picture and still picture, playback time of contents, physical data storage address at which the content files are stored, copyright protection information as playback conditions and copying conditions of the contents and creation date and time of the contents.

Since information required in displaying a list of the contents files is collectively stored in the index file 300, it becomes unnecessary to search all of the stored contents files, thereby reducing the processing of the data processing apparatus 200.

The search information storage area 132 is an area for storing information, e.g. record address, required when the data processing apparatus 200 takes out each data stored in the data storage area 131 therein. In this embodiment, the record address is managed in a FAT file system and the information needed in the FAT file system is recorded in the search information storage area 132. Another file system such as UDF may be used and the record address may be managed without using the file system.

Since a block configuration of the data processing apparatus 200 in embodiment 2 is the same as that in embodiment 1 and is shown in FIG. 3, detailed description thereof is omitted.

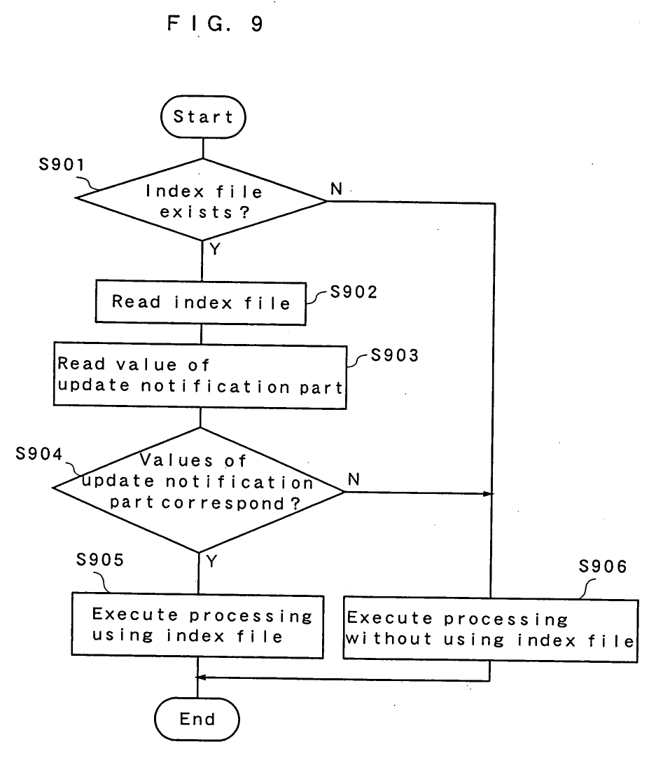

Hereinafter, operations of blocks constituting the recording medium 100 and data processing apparatus 200 will be described using figures. FIG. 9 is a flowchart showing an operation sequence of the data processing apparatus 200 in the case where the recording medium 100 is mounted to the data processing apparatus 200. At a step S901, the data processor 230 reads the information in the search information storage area 132 of the recording medium 100 attached to the slot 210 via the input/output processor 220 and determines whether or not the index file 300 exists in the data storage area 131. When the index file 300 exists, the operation proceeds to the processing at a step S902 and when not exist, the operation proceeds to a processing of a step S906.

At the step S902, the data processor 230 reads the index file 300 of the recording medium 100 attached to the slot 210 via the input/output processor 220 on the memory. The information in the search storage area 132 is used as positional information of the index file 300 in the data storage area 131. At a step S903, the data processor 230 reads the value of the update notification part 140 of the recording medium 100 attached to the slot 210 via the input/output processor 220 and temporarily stores the value on the memory.

In a step S904, the update information in the update notification part 140 read at the step S903 is compared to the update information in the update information field of the index file 300 read at the step S902. When above both update information correspond to each other, the operation proceeds to processing of a step S905. When above both update information do not correspond to each other, the operation proceeds to processing of a step S906. At the step S905, after the index file 300 of the recording medium 100 attached to the slot 210 is created, the data processor 230 determines that data in the recording area 130 is not updated. Then, the processing using the information in the index file 300 is performed. The processing using the information in the index file 300 is to output a list of the contents data, for example, stored in the recording medium 100 to the display processor 250.

In the step S906, the data processor 230 performs a processing without using the index file 300 regardless the existence of the index file 300. For example, information in the data search information storage area 132 of the recording medium 100 is read and the list of the contents data stored in the recording medium 100 is output to the display processor 250. Since the index file 300 is not used at this time, information for every contents data needs to be sequentially read from the search information storage area 132, resulting in a longer processing time.

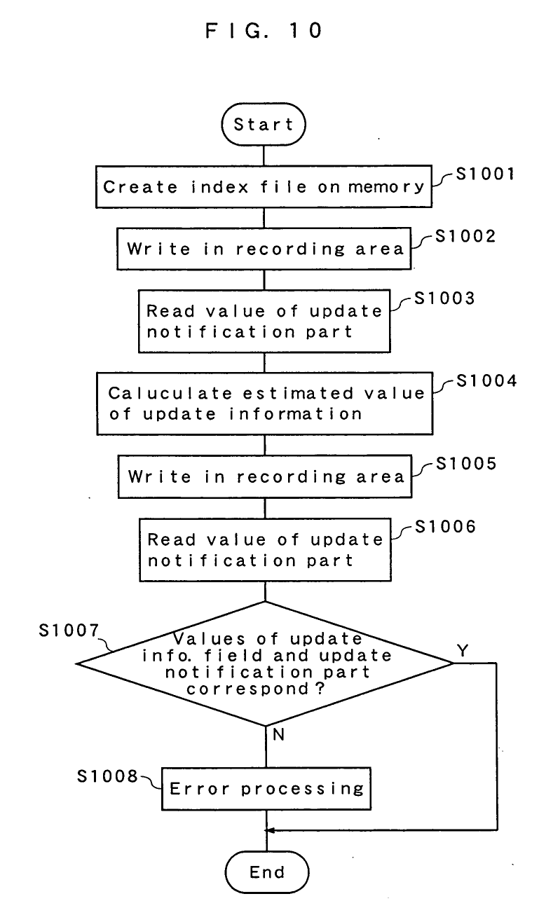

FIG. 10 is a flowchart showing an operation sequence in which the data processing apparatus 200 creates the index file 300 in the recording medium 100. At a step S1001, the data processor 230 searches the contents data stored in the recording medium 100 using the information in the data search information storage area 132. Then, information is collected by reading the information of the contents data and the index file is created on the memory. In the index file on the memory, the update information field stores 0 as a value indicating invalidity therein.

At a step S1002, the data processor 230 writes the index file on the memory created at the step S1001 to the recording area 130 of the recording medium 100 via the input/output processor 220. At a step S1003, the data processor 230 reads the update information in the update notification part 140 of the recording medium 100 attached to the slot 210 via the input/output processor 220 and temporarily stores the update information on the memory. At a step S1004, a next value is added to a value of the update information in the update notification part 140 read at the step S1003. That is, when the update information in the update information field of the index file 300 created in the recording medium 100 is updated at the step S1002, an estimated value by which the update notification part 140 of the recording medium 100 increments is added. For example, only one writing is required, the increment value is set as 1. A value thus calculated is referred to as an estimated update information value.

At a step S1005, the data processor 230 overwrites the estimated update information value calculated at the step S1004 in the update information field of the index file 300 created in the recording medium 100. That is, the estimated update information value is written to the recording area 130 of the recording medium 100. At a step S1006, the data processor 230 reads the value of the update notification part 140 of the recording medium 100 attached to the slot 210 via the input/output processor 220 and temporarily stores the value on the memory. At a step S1007, the value of the update information in the update notification part 140 read at the step S1006 is compared to the estimated update information value calculated at the step S1004. When above both values correspond to each other, the processing of creating the index file 300 is completed. When above both values do not correspond to each other, the operation proceeds to a step S1008. At the step S1008, it is determined that an error occurs during creation of the index file 300, and the error processing is performed and finished.

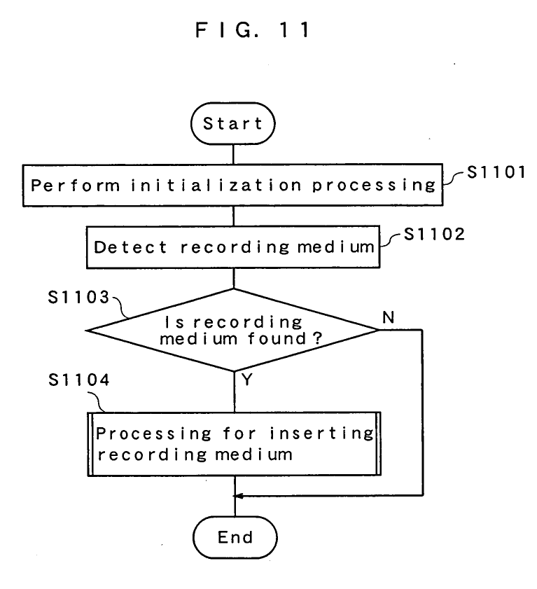

FIG. 11 is a flowchart showing an operation sequence at the time of power-on of the data processing apparatus 200. At a step S1101, when the power of the data processing apparatus 200 is turned on, the input/output processor 220, data processor 230, user input processor 240 and display processor 250 in the data processing apparatus 200 perform initialization processing. The initialization processing is processing of performing initial setting of hardware and software and includes clearance of the internal memory and setting of initial value. At a step S1102, the input/output processor 220 detects whether or not the recording medium 100 is attached to the slot 210. At a step S1103, when it is found that the recording medium 100 is attached to the slot 210 as a result of detection at the step S1102, the operation proceeds to a step S1104. When not attached, the processing at the time of power-on is completed. At the step S1104, after the operation sequence shown in FIG. 9 is performed in the recording medium 100 attached to the slot 210, the processing at the time of power-on is completed.

In each of the operation sequences of FIGS. 9 to 11, the display processor 250 may display the progress and operation results to the user.

As described above, since the index file 300 stored in the recording medium 100 of the present invention includes the update information in the update notification part 140 of the recording medium 100 at the time of creation, the data processing apparatus 200 can easily determine whether or not the recording area 130 of the recording medium 100 has been updated after the index file 300 was created.

In other words, it is possible to easily determine, without confirming each contents data, whether or not the contents data has not been changed since the index file 300 was created in the readable and writable recording medium 100.

Thereby, when the index file 300 has not been changed, it becomes possible to notify the list of the contents files stored in the recording medium 100 by using the index file 300 to the user in a short time.

Although the present invention has been described based on above-mentioned embodiment, as a mater of course, the present invention is not limited to above-mentioned embodiment. Modification can be made as far as it does not deviate from the scope of the present invention. Cases (2-1) to (2-9) described below are included in the concept of the present invention.

(2-1) In this embodiment, in the operation sequence in the case where the recording medium 100 is mounted to the data processing apparatus 200, only the update information in the update notification part 140 is used when it is determined whether or not the index file 300 is used. However, the value of the medium ID holder 150 in addition to the update information may be used. That is, determination is made whether or not the value of the medium-specific ID field of the index file 300 corresponds to the value of the medium ID holder 150 of the recording medium 100, and when above both values do not correspond to each other, the index file 300 need not be used. Thus, the index file 300 created for another recording medium is copied to the recording medium 100 and therefore, malfunction in the case where the value happens to correspond to the update information in the update notification part 140 can be avoided.

(2-2) The field provided in the index file 300 described in this embodiment is only an example. According to the present invention, the update information field which stores the update information in the update notification part 140 is indispensable and even when the other fields are added or deleted, the effects of the present invention can be realized.

(2-3) Although the procedures of reading and writing data in embodiment 1 are not used in this embodiment when reading and writing the data to and from the recording medium 100, the procedures may be used at the same time. Thus, error detection in reading and writing of the data can be strictly performed.

(2-4) Although the operation sequence in the case of newly creating the index file 300 is described in this embodiment, when the index file 300 already exists and the data processor 230 figures out the contents of update of the recording area 130, it is unnecessary to recreate a new index file. Therefore, the processing at the step S1001 may be further simplified and however, the processing after that is identical.

(2-5) Although the value indicating invalidity at the step S1001 is set to be 0 in this embodiment, it is not limited to this. Any value indicating invalidity may be used.

(2-6) Even when a part or whole of the contents file or index file is encrypted, the present invention still has effectiveness.

(2-7) Although the update information field is provided in the file of the data storage area 131 and the update information in the update notification part 140 is stored in the file in this embodiment, a field for storing the update information of the update notification part 140 therein may be provided in the search information storage area 132. That is, the search information storage area 132 may store the update information in the update notification part 140 at the time when each data is recorded to the recording medium 100 in addition to the recording address of each data in the data storage area.

(2-8) Although the estimated update information value is overwritten in the update information field of the index file 300 in the processing at the step S1005 in this embodiment, it may specifically be performed as follows.

When data is written using the file system, the file system manages the address at which the data of each file is stored and an application using the file system is not engaged in the management. Then, the file system may have a function of the overwriting in the update information field. Alternatively, the file system may have a means for notifying the address at which the update information field of the index file 300 is stored to the application. Then, the application may directly overwrite the update information of the update information field on the basis of the address information.

(2-9) In this embodiment, the update information in the update notification part 140 is necessary read at the step S903 after the processing at the step S902. However, when 0 as a value indicating invalidity is stored in the update information field of the index file 300, the operation may immediately proceed to the processing at the step S906.

### Embodiment 3

Next, a recording medium and data processing method in accordance with embodiment 3 of the present invention will be described based on figures. Since a configuration of the recording medium 100 in embodiment 3 is the same as the configuration of embodiment 1 and the same as the configuration shown in FIG. 1, detailed description thereof is omitted.

The recording medium 100 in embodiment 3 must perform initialization processing at least once before the data processing apparatus 200 writes and reads data and has a command for performing the initialization processing.

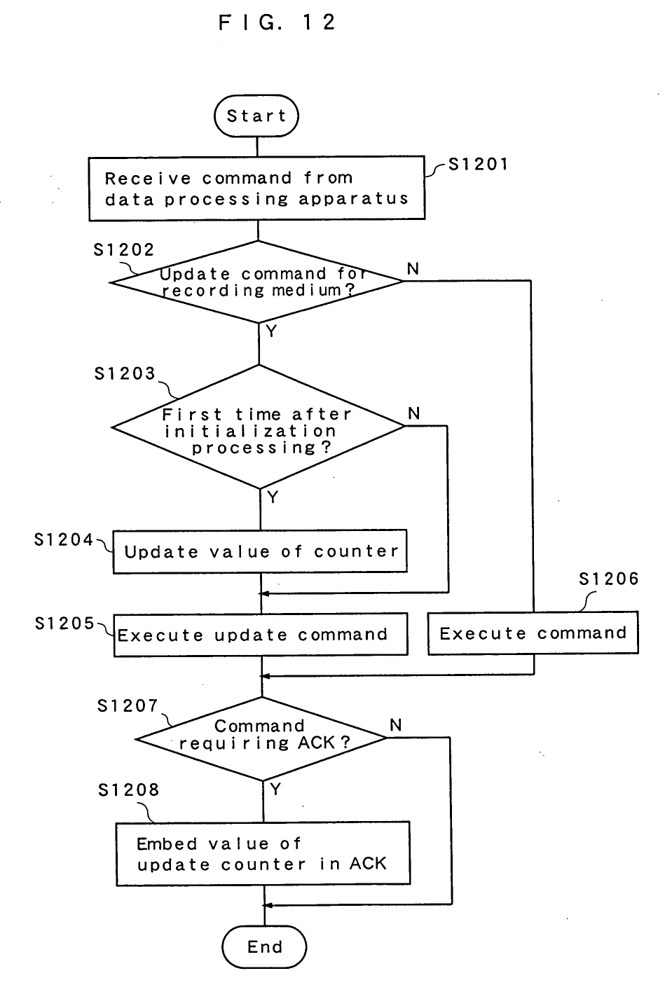

FIG. 12 is a flowchart showing an operation sequence in the case where the recording medium 100 receives the command from the data processing apparatus 200. At a step S1201, when receiving the command from the data processing apparatus 200, the host interface part 110 notifies the command to the controller 120. At a step S1202, the controller 120 determines the type of the command notified at the step S1201 and determines whether or not the command is a command to update the recording area 130. The command to update the recording area 130 is, for example, the write command to write the data or erase command to erase the data. When it is the command to update, the operation proceeds to a processing at a step S1203. When it is the other command, the operation proceeds to processing at the step S1206. The other command is, for example, the read command to read the data.

At the step S1203, the controller 120 determines whether or not it is the command to first update the recording area 130 after initialization processing. In the case of the first updating area, the operation proceeds to a processing at the step S1204. When it is not the first, the operation proceeds to a processing at a step S1205. At the step S1204, the controller 120 increments the value of the update information in the update notification part 140. Although the increment means addition of 1 in this embodiment, it is not limited to this. At the step S1205, the controller 120 executes the received command. For example, when the command is the write command, the data received from the data processing apparatus 200 is written to recording area 130. When the command is the erase command, the data at the corresponding address in the recording area 130 is erased. If the processing is completed, the operation proceeds to a step S1207.

At the step S1206, the received command (read command and the like) is executed and the operation proceeds to the step S1207. At the step S1207, when the type of the received command requires the recording medium 100 to return the response value (ACK) to the data processing apparatus 200 and a field which stores the update information in the update notification part 140 therein is prepared in the response value (ACK), the operation proceeds to a step S1208. When not prepared, the processing is finished. At the step S1208, the current update information in the update notification part 140 is embedded in the response value (ACK) and transmitted to the data processing apparatus 200 to complete the processing.

As described above, after the initialization processing, the recording medium 100 in embodiment 3 updates the value of the update notification part 140 immediately before the data of the recording area 130 is updated. Although the value of the update notification part 140 is updated for every write command or erase command in embodiments 1 and 2, only one update is required after initialization in this embodiment. Thus, when the recording medium is mounted to the data processing apparatus and continuously used without being removed, rewriting of the update information becomes unnecessary, thereby shortening the processing time.

In this embodiment, it is assumed that the recording medium 100 has a command by which the data processing apparatus 200 increments the value of the update information in the update notification part 140 at any timing.

In this embodiment, it is assumed that the recording medium 100 has a command by which the data processing apparatus 200 reads the value of the update notification part 140 at any timing.

Next, a data processing apparatus in accordance with embodiment 3 will be described. The block configuration of the data processing apparatus 200 is the same as that of embodiment 1. Here, the detailed description of the configuration is omitted and the operation of each part is described using figures.

Since an operation sequence of the data processing apparatus 200 in the case where the recording medium 100 is mounted to the data processing apparatus 200 in embodiment 3 is the same as that of embodiment 2 as shown in FIG. 9, detailed description thereof is omitted.

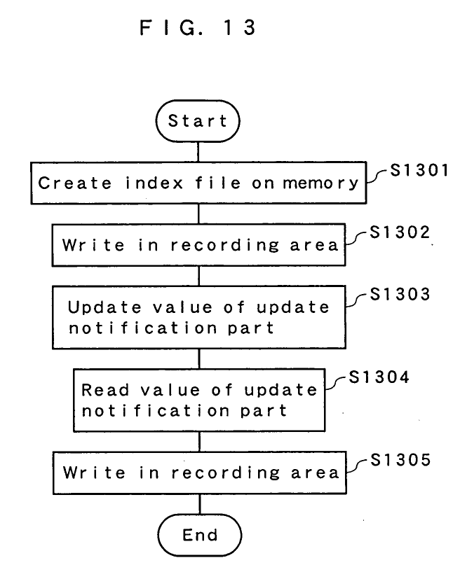

FIG. 13 is a flowchart showing an operation sequence in which the data processing apparatus 200 creates the index file in the recording medium 100. At a step S1301, the data processor 230 uses the information in the search information storage area 132 of the data to search contents data stored in the recording medium 100. By reading the information of the contents data, the information is collected and the index file is created on the memory. In the index file on the memory, the update information field stores 0 as the value indicating invalidity therein. At a step S1302, the data processor 230 writes the index file on the memory created in the step S1301 to the recording area 130 of the recording medium 100 via the input/output processor 220. At a step S1303, the data processor 230 issues a command to increment the value of the update information in the update notification part 140 via the input/output processor 220 to the recording medium 100 attached to the slot 210.

At a step S1304, the data processor 230 reads the update information in the update notification part 140 of the recording medium 100 attached to the slot 210 via the input/output processor 220 and temporarily stores the value in the memory. At a step S1305, the update information in the update notification part 140 read at the step S1304 is overwritten in the update information field of the index file 300 created in the recording medium 100. That is, the update information is written in the recording area 130 of the recording medium 100.

In the example of the operation sequence in FIG. 13, the update information field is written at the last for the following reason.

When the recording medium 100 is removed from the slot 210 or the power is turned off while the index file 300 is written to the recording area 130, an invalid index file 300 is created. As shown in the example of the operation sequence in FIG. 9, determination is made whether or not the index file is invalid by using the value of the update information field. Therefore, by updating the update information field of the index file 300 at the last, it is possible to determine the invalid index file 300.

Since an operation sequence of the data processing apparatus 200 at the time of power-on in embodiment 3 is the same as that of embodiment 2 as shown in FIG. 11, detailed description thereof is omitted.

As described above, since the index file 300 stored in the recording medium 100 of this embodiment includes the update information in the update notification part 140 of the recording medium 100 at the time of creation, in the data processing apparatus 200, it is possible to easily determined whether or not the recording area 130 of the recording medium 100 has been updated by another data processing apparatus after the index file 300 was created.

This is due to that initialization processing necessarily occurs when writing is performed in another data processing apparatus and thus the value of the update information in the update notification part 140 is incremented. As a result, the value of the information update field of the index file 300 is different from the value of the update notification part 140. Therefore, in the readable and writable recording medium 100, it is possible to easily determine whether or not the contents data has not been changed since the index file 300 was created without confirming each contents data.

Thereby, when the index file 300 is not changed, it becomes possible to notify the list of the contents files stored in the recording medium 100 to the user in a short time using the index file 300.

Although the present invention has been described based on the above-mentioned embodiment, it is needless to say that the present invention is not limited to the above-mentioned embodiment. Modification can be made as far as it does not deviate from the scope of the present invention. Cases (3-1) to (3-8) described below are included in the concept of the present invention.

(3-1) In this embodiment, although only the update information in the update notification part 140 is used when it is determined whether or not the index file 300 is used in the operation sequence of a case where the recording medium 100 is mounted to the data processing apparatus 200 in this embodiment, the value of the medium unique ID 150 may be also used.

That is, determination is made whether or not the value of the medium-specific ID field of the index file 300 corresponds to the value of the medium unique ID 150 of the recording medium 100 and when above both values do not correspond to each other, the index file 300 need not be used.

Thus, since the index file 300 created for another recording media is copied to the recording medium 100, malfunction at the time when the value happens to correspond to the value of the update notification part 140 can be avoided.

(3-2) The field provided in the index file 300 described in this embodiment is only an example. The update information field which stores the update information in the update notification part 140 therein is indispensable to the present invention and even when other fields are added or eliminated, the effect of the present invention can be realized.

(3-3) In this embodiment, although the procedure described in embodiment 1 of reading and writing data to and from the recording medium 100 is not used, this procedure may be used at the same time. It enables more strict error detection in reading and writing of the data.

(3-4) In this embodiment, the operation sequence of creating the new index file 300 is described. However, when the index file 300 already exists and the data processor 230 figures out the contents of update of the recording area 130, it is unnecessary to recreate a new index file. Therefore, although the processing at the step S1001 may be further simplified, the subsequent processing is the same.

(3-5) Although the value indicating invalidity is set to be 0 at the processing at the step S1301 in this embodiment, the value is not limited to 0. Any value indicating invalidity may be used.

(3-6) The present invention is effective even if some or whole of the contents file or index file is encrypted.

(3-7) Although the update information field is provided in the file of the data storage area 131 to store the update information in the update notification part 140 therein in this embodiment, a field which stores the value of the update notification part 140 may be provided in the search information storage area 132. That is, the search information storage area 132 may store the update information of the time when each data is recorded to the recording medium 100 in the update notification part 140 in addition to the recording address of each data in the data storage area.

(3-8) In this embodiment, the data processing apparatus 200 uses the update information in the update notification part 140 to confirm the contents of the index file 300. However, the value of the update notification part 140 may be used merely to determine whether or not another data processing apparatus updates the recording area 130 of the recording medium 100.

For example, to determine validity of the cache information as described in embodiment 1, the update information in the update notification part 140 may be used. The cache information is certainly cleared when writing occurs and a command to increment the value of the update notification part 140 is issued, thus, the same effect as that of embodiment 1 can be obtained.

### INDUSTRIAL APPLICABILITY

Since the recording medium, data processing apparatus and data processing method of the present invention are provided with the update notification part updated immediately before writing to the recording medium, they can be used for application requiring confirmation of validity of the cache information and confirmation of validity of the index file.

1. A recording medium comprising:
a nonvolatile recording area for storing data;
an update notification part for updating update information of the time of writing or erasing of data to said recording area and holding said update information;
a host interface part for communicating with a data processing apparatus; and
a controller for reading and writing data from and to said recording area and supplying the data in said recording area and said update information to said data processing apparatus via said host interface part,
wherein update information in said update notification part can be read from said data processing apparatus and cannot be written by said data processing apparatus.

2. The recording medium according to claim 1, wherein update information in said update notification part is updated immediately before the data in said recording area is updated.

3. The recording medium according to claim 1, comprising a medium-specific ID unique to each of said recording medium.

4. The recording medium according to claim 1, wherein a plurality of pairs of said recording areas are provided and update information in said update notification part is updated immediately before any of pairs of data of said recording areas is updated.

5. The recording medium according to claim 1, wherein a plurality of pairs of said recording areas and said corresponding update notification parts are provided and update information in each of said update notification parts is updated immediately before data of said recording area respectively corresponding to the update information is updated.

6. The recording medium according to claim 5, wherein a pair of a recording area which can be arbitrarily read and written by said data processing apparatus and said update notification part corresponding to the recording area, and a pair of a recording area which can be read and written when a specific authentication processing succeeds and said update notification part corresponding to the recording area are provided.

7. The recording medium according to claim 1, wherein update information in said update notification part is inserted into a response value corresponding to a command issued from said host device.

8. The recording medium according to claim 1, wherein update information in said update notification part is updated only immediately before data of said recording area is first updated after initialization processing of said recording medium.

9. The recording medium according to claim 1, wherein update information in said update notification part makes update to the arbitrary timing which the data processing apparatus specifies possible after initialization processing of said recording medium.

10. The recording medium according to claim 1, wherein update information in said update notification part is updated each time write-protection of said recording area is canceled.

11. The recording medium according to claim 1,
wherein said recording area includes: a data storage area which stores one or more pieces of data; and a search information storage area which stores search information required when the data processing apparatus takes out each data stored in said data storage area, and
at least one of said data storage areas has a field for storing update information in said update notification part.

12. The recording medium according to claim 1, wherein said recording area includes: a data storage area which stores one or more pieces of data; and a search information storage area which stores search information required when the data processing apparatus takes out each data stored in said data storage area, and
said search information storage area has the field for storing update information in said update notification part immediately after said data is updated.

13. A data processing apparatus comprising:
a slot to which said recording medium is attached;
an input/output processor for performing input/output processing with said recording medium attached to the slot;
a data processor for reading data of said recording medium via said input/output processor and temporarily storing the data, and performing a data processing on the basis of update information read from the said recording medium in said update notification part when a recording medium includes a nonvolatile recording area for storing data, an update notification part for updating update information to said recording area at the time of writing or erasing of the data and holding said update information, a host interface part for communicating with a data processing apparatus, and a controller for reading and writing data from and to said recording area and supplying the data in said recording area and said update information to said data processing apparatus via said host interface part.

14. A data processing method, wherein a recording medium includes: a nonvolatile recording area for storing data; an update notification part for holding update information of data; and a controller for reading and writing data from and to said recording area and supplying the data in said recording area and said update information to a data processing apparatus,
and said data processing apparatus includes: a slot to which said recording medium is attached; and a data processor for reading data of said recording medium attached to said slot and temporarily storing the data and performing a data processing on the basis of update information read from said recording medium in said update notification part, comprising the steps of:
making it possible for update information in said update notification part to be read from said data processing apparatus and impossible for update information to be written by said data processing apparatus; and
updating said update information by said controller at the time of writing or erasing of data to said recording area.

15. The data processing method according to claim 14 comprising the steps of:
reading update information in said update notification part and storing the update information in said data processor after the data processing to said recording medium is performed; and
determining whether or not data of said recording area in said recording medium has been updated by reading update information in said update notification part of said recording medium and by determining whether or not the update information corresponds to update information stored in said data processor when the data processing to the recording medium is started.

16. The data processing method according to claim 14 comprising the steps of:
reading update information in said update notification part and storing the update information in said data processor after write-protection to said recording medium is set,
determining whether or not a history that write-protection set in said recording medium has been canceled by reading update information in said update notification part of said recording medium and determining whether or not the update information corresponds to update information stored in said data processor exists when the data processing to the recording medium is started.

17. The data processing method according to claim 14 comprising the step of:
determining whether or not data of said recording area in said recording medium has been updated after said data was recorded by determining whether or not update information of field in the recording area read from said recording medium corresponds to update information in said update notification part read from said recording medium.

18. The data processing method according to claim 14 comprising the step of:
conforming value of said field immediately after writing to said field to value of said update notification part, when data is written to said recording medium, by reading update information in said update notification part after writing the whole of said data, and by calculating and recording update information immediately after writing in field in the recording area which stores the update information in said update notification part.

19. The data processing method according to claim 14 comprising the steps of:
comparing update information in said update notification part before reading of data from said recording medium to update information in said update notification part after reading of data;
confirming whether or not above both update informations correspond to each other; and
continuing processing in the case of correspondence, and if not in the case of correspondence, performing an error processing or retry processing.

20. The data processing method according to claim 14 comprising the steps of:
comparing update information in said update notification part before writing of data from said recording medium to update information in said update notification part after writing of data;
confirming whether or not above both update information correspond to each other; and
performing error processing or retry processing in the case of correspondence, and if not in the case of correspondence, continuing processing.
